(19) United States
(12) Patent Application Publication
(10) Pub. No.: US 2007/0084904 A1
(43) Pub. Date: Apr. 19, 2007

(54) Conductive ball, formation method for electrode of electronic component, electronic component and electronic equipment

(75) Inventors: Masato Sumikawa, Kashihara-shi (JP); Rina Murayama, Tenri-shi (JP); Masashi Ogawa, Yamatokoriyama-shi (JP); Kiyoto Matsushita, Koka-gun (JP)

Correspondence Address: NIXON & VANDERHYE, PC, 901 NORTH GLEBE ROAD, 11TH FLOOR, ARLINGTON, VA, 22203, US

(73) Assignees: SHARP KABUSHIKI KAISHA, OSAKA (JP); SEKISUI CHEMICAL CO., LTD., OSAKA (JP)

(21) Appl. No.: 10/557,698

(22) PCT Filed: May 24, 2004
(86) PCT No.: PCT/JP04/07407

§ 371 Date: Nov. 8, 2006

(30) Foreign Application Priority Data
May 22, 2003 (JP) 2003-145160

(51) Int. Cl. A47J 36/02

(52) U.S. Cl. 228/101

(57) ABSTRACT

A conductive ball is formed by coating a generally spherical-shaped core made of a non-metallic material with a coating layer composed of a Cu layer and an Sn-5.5Ag alloy layer of non-eutectic composition. The conductive ball is disposed on a land of an electronic component via flux and reflown at heating temperatures whose peak temperatures reach 250 to 260° C. The Sn-5.5Ag alloy of non-eutectic composition is put in the state in which a solidus portion and a liquidus portion coexist to keep flowability relatively small. The conductive ball is fixed on the land without exposing an SnCu layer formed on the Cu layer. An electrode is formed without exposing the SnCu layer having relatively poor solder wettability. Between the electronic component and a circuit board, a joint section having a good electric conduction property and mechanical strength may be formed.

### BACKGROUND OF THE INVENTION

The present invention relates to a conductive ball, a formation method for an electrode of an electronic component, an electronic component and electronic equipment.

In recent years, with demands for reduction in size and weight of electronic equipment as typified by cell-phones and portable information devices, reduction in size and increase in density of electronic components are being pursued. Accordingly, there have been proposed a bear chip mounting structure in which LSI (Large Scale Integrated Circuit) chips as electronic components are directly mounted on a circuit board and a mounting structure in which electronic components whose shape and size are as close as possible to those of LSI chips, i.e., electronic components of chip size packages (hereinbelow referred to as CSPs), are mounted on a circuit board. These mounting structures are characterized by electrodes disposed on the bottom surfaces of electronic components for achieving high packing density.

In these mounting structures, due to difference in thermal expansion coefficient between electronic components such as the bear chips and the CSPs and a circuit board on which the electronic components are mounted, thermal distortion attributed to thermal stress is generated in joint sections between the electronic components and the circuit board. The distortion causes metals forming the joint sections to be fatigued and to have cracks, which in the end leads to rupture of the joint sections, thereby causing a problem of operation failure of electronic equipment with these electronic components mounted thereon. In order to prevent such a problem, a thermal stress relaxation structure for relaxing the thermal stress in the joint sections is required. However, it is difficult to incorporate such a thermal stress relaxation structure into miniaturized electronic components and high pin count packages.

FIG. 6 is a cross sectional view showing a joint section between a conventional electronic component and a circuit board (see, e.g., JP 2000-315707 A, FIG. 2). In FIG. 6, there are shown an electronic component 5, a land 6 of the electronic component, a circuit board 11, a land 12 of the circuit board, and a joint section 14 by soldering. When a heat cycle involving repeated rise and fall of temperature acts upon the structure shown in FIG. 6, the joint section 14 suffers metal fatigue due to difference in thermal expansion coefficient between the electronic component 5 and the circuit board 11. The metal fatigue causes cracks and ruptures to the joint section 14, which sometimes leads to disconnection. Even in the case where the joint section 14 is sufficiently soldered during mounting operation, the problem of disconnection can arise when difference in thermal expansion coefficient between the electronic component 5 and the circuit board 11 is large, e.g., when the electronic component 5 is a wafer level CSP mostly formed of a Si (silicon) chip, and the circuit board 11 is a printed board made of organic materials.

In order to prevent such a problem, a conductive ball as shown in FIG. 7 has been proposed recently (see, e.g., JP 2001-93329 A). The conductive ball 1 includes a generally spherical-shaped core 4 made of polymer, a Cu (cupper) layer 3 for coating the surface of the core 4, and a solder layer 16 made of SnPb (tin, lead) for covering the surface of the Cu layer 3. With use of the conductive ball 1, as shown in FIG. 8, a joint section 14 is formed between the electronic component 5 and the circuit board 11. With the presence of the core 4, the joint section 14 in FIG. 8 has a gap between the electronic component 5 and the circuit board 11 larger than the gap in FIG. 6, and cracking and rapture of the joint section 14 are prevented by relaxing the thermal stress attributed to difference in thermal expansion coefficient between the electronic component 5 and the circuit board 11.

FIGS. 9A, 9B and 9C are views showing the steps of forming a joint section using a conventional conductive ball. First, as shown in FIG. 9A, the conductive ball 1 is temporarily fixed onto the land 6 of the electronic component 5 by viscosity of flux 7. The conductive ball 1 is heated to a temperature higher than the melting point of the solder layer 16, and then a solder section 10 is formed by reflow of the solder layer 16 and an external electrode 8 as shown in FIG. 9B is formed. The external electrode 8 is a composite electrode having the nonmetallic core 4.

The electronic component is mounted on the circuit board 11 together with a number of other electronic components with external electrodes identical to that of FIG. 9B formed thereon. In the mounting step, a soldering paste is fed onto the land 12 of the circuit board 11, and the top end of the external electrode 8 of the electronic component is disposed on the paste on the land. The state in this step is shown in FIG. 9C. In FIG. 9C, reference numeral 13 denotes a soldering paste fed onto the circuit board.

In the state shown in FIG. 9C, the circuit board and the electronic component are heated to a temperature higher than the melting points of the soldering paste 13 and the solder section 10, typically to the temperature range of 230° C. to 250° C., so as to form the joint section 14 as shown in FIG. 8.

However, using the conventional conductive ball 1 brings about a problem that joint failure may occur between the electronic component 5 and the circuit board 11 as shown in FIG. 10. In FIG. 10, a solder section 10 of the external electrode in the electronic component and the solder on the land 12 of the circuit board do not mix and an interface 17 is formed. The interface 17 causes a problem that a sufficient electric conduction property cannot be obtained between the electronic component 5 and the circuit board 11. Moreover, the interface 17 causes a problem that mechanical strength of the joint section becomes extremely low. The joint section having the interface 17 has a problem that even if a sufficient electric conduction property is obtained, the mechanical strength is too low to prevent disconnection, thereby causing poor reliability.

An inventor of the present invention has found out that the cause of the joint failure occurring in the joint section between the electronic component and the circuit board in the case of using a conductive ball having a core made of a nonmetallic material is inherent at the point that an external electrode is formed on the electronic component.

For example, in the case where an external electrode is formed by the prior art, the conductive ball 1 on the land 6 of the electronic component 5 is heated to reflow the solder layer 16 of the conductive ball as shown in FIG. 9A, so that an SnCu compound layer 9 is formed on the surface of the Cu layer 3 as shown in a schematic view of FIG. 11. The SnCu compound, which is formed of Cu in the Cu layer 3 and Sn contained in the solder layer 16, is relatively poor in solder wettability. Eventually, a melted solder that is a melted solder section 10 falls toward the land 6 as shown in FIG. 11, as a result of which the SnCu compound layer 9 is exposed from the top end of the external electrode 8 on the opposite side of the land 6. The solder wettablility of SnCu is considerably deteriorated by oxidation. Therefore, the SnCu compound layer 9 exposed from the top end of the external electrode 8 hardly mixes with the solder on the circuit board 11 side and the interface 17 as shown in FIG. 10 is generated, which causes failures in the joint section between the electronic component 5 and the circuit board 11. The present invention has been invented based on such a finding of the cause of the failures of the joint section.

It is a primary object of the present invention to provide a conductive ball and a formation method for an external electrode, which allow formation of a joint section having a sufficient electric conduction property and mechanical strength in between an electronic component and a circuit board.

### SUMMARY OF THE INVENTION

In order to accomplish the object, a conductive ball of the present invention includes:

a core formed in a generally spherical shape and formed of a nonmetallic material; and

a coating layer coating a surface of the core and having at least a first metal layer and a second metal layer, wherein,

the first metal layer is made of a first alloy containing Sn and having noneutectic composition, and

the second metal layer is made of a second alloy containing at least either Cu or Ni.

According to this structure, the first metal layer forming the coating layer is made of a first alloy, and the first alloy has noneutectic composition. Therefore, the first alloy has two melting points of a solidus line and a liquidus line, so that at the temperatures in between the solidus temperature and the liquidus temperature, a solidus portion and a liquidus portion are in the state of coexistence. The first alloy in this state is lower in flowability than that in a totally melted state. Therefore, the conductive ball of the present invention is disposed, for example, on the land of an electronic component via a material containing flux, and is heated to temperatures corresponding to those in between the solidus temperature and the liquidus temperature, so that the first alloy flows while keeping the state of covering the core and the second metal layer, and mixes with a solder on the land of the electronic component. As a result, when, for example, electrodes of electronic components are formed of the conductive balls, joint failure attributed to the disclosure of the second metal layer as seen in the conventional example can be avoided, and the electrodes can be fixed onto the lands of the electronic components with sufficient strength.

Moreover, the second alloy which forms the second metal layer contains at least either Cu or Ni, and therefore when at least a part of the first alloy which forms the first metal layer melts, wettability is effectively achieved between the second metal layer and the melted part of the first alloy, which allows the core and the coating layer to be retained integrally.

Moreover, the core formed of a nonmetallic material can gain elasticity when it is formed of, for example, resin, and therefore by using the conductive ball for forming, for example, a joint section between an electronic component and a circuit board, stress generated in the joint section can effectively be relaxed by the core, thereby allowing effective prevention of cracks and fractures in the joint section.

In one embodiment, the first alloy has composition in which a liquidus temperature rises when a proportion of Sn in composition decreases.

According to the embodiment, when the conductive ball is heated to a specified temperature corresponding to the temperature in between the solidus temperature and the liquidus temperature, the proportion of Sn in the composition decreases because Su contained in the first alloy reacts with a metal contained in the second metal layer. In the first alloy, the liquidus temperature rises due to decrease in the composition proportion of Sn, which stably retains the coexistent state of a solidus portion and a liquidus portion. As a result, in the first alloy, relatively low flowability is stably retained, which reliably prevents the second metal layer from being exposed.

In one embodiment, the first alloy has composition closer to eutectic composition than to composition whose constituent forms an intermetallic compound.

When an alloy has composition slightly off the eutectic composition, a part of dominant element among elements constituting the composition becomes a solid solution and is crystallized earlier as a primary crystal, whereas portions other than this primary crystal become structures having refined crystal grains similar to those in eutectic composition. These alloy structures are good in mechanical properties and are suitable for practical application.

In the case where alloys contain elements forming intermetallic compounds, the intermetallic compounds are formed in the alloy structures at temperatures equal to or lower than the melting points of these intermetallic compounds. The intermetallic compounds themselves generally have hard and fragile characteristics and are deemed not appropriate as joint members.

Herein, according to the above embodiment, the first alloy has composition closer to the eutectic composition than to the intermetallic compound composition, so that an alloy structure similar to the eutectic composition appears together with an intermetallic compound, which provides good mechanical strength and high reliability.

In one embodiment, the first alloy has composition in which a liquidus temperature is 240° C. or higher.

In the case where the conductive ball is fixed onto a land of an electronic component formed by using, for example, Cu or Ni through, for example, reflow operation, what is necessary first is a heating temperature condition capable of ensuring sufficient joining. Particularly in the case of joining Ni on the land and a solder member, 240° C. or higher temperatures are necessary.

According to the above embodiment, the first alloy has composition in which the liquidus temperature is 240° C. or higher, and this makes it possible to establish a relatively low flowability state in which a solidus portion and a liquidus portion coexist for reflow joint process at 240° C. or higher. As a result, when an electrode is formed on the electronic component with use of the conductive ball, and the electronic component is mounted on a circuit board, joint failure and the like between the electrode and the circuit board electrode can effectively be prevented.

In one embodiment, the first alloy has composition in which a liquidus temperature is 260° C. or higher.

In the case where the conductive ball is fixed onto a land of an electronic component formed by using, for example, Cu and Ni through, for example, by reflow operation, the heating temperature should be a temperature which the electronic component itself can withstand and which does not cause decrease in joint strength due to excessive formation of intermetallic compounds. It is generally preferable that the temperature should be 260° C. or lower depending on the type of electronic components and the type of joint alloys.

According to the above embodiment, the first alloy has composition in which the liquidus temperature is 260° C. or higher, so that in the reflow joining process at 260° C. or lower, the alloy never reaches the liquidus temperature. Therefore, the relatively low flowability state in which a solidus portion and a liquidus portion coexist is effectively retained. As a result, when an electrode is formed on the electronic component with use of the conductive ball, it becomes possible to prevent failures of the electronic component and to prevent reduction in joint strength between the first alloy and the land. Further, when the electronic component is mounted on a circuit board, joint failure and the like between the electrode and a circuit board electrode can effectively and reliably be prevented.

In one embodiment, the first alloy contains Ag, and a proportion of the Ag in composition is larger than 3.5 weight %.

According to this embodiment, in the case where the conductive ball is used to form, for example, an electrode, and the electrode is connected to, for example, a circuit board, the joint section may fulfill sufficient strength and heat resistance.

Moreover, in the first alloy, the proportion of the Ag in composition is larger than 3.5 weight %, and therefore when the compositional proportion of Sn contained in the first alloy decreases, the liquidus temperature rises, so that the coexistent state of a solidus portion and a liquidus portion during, for example, reflow operation is effectively retained, thereby allowing effective prevention of failures in, for example, an electrode formed with use of the conductive ball.

Moreover, the first alloy containing Ag has a melting point in eutectic composition relatively close to the melting point in SnPb alloys which are widely used in conventional solders, and this allows easy replacement of conductive balls using the SnPb alloys with the conductive balls in the present embodiment.

In one embodiment, the first alloy contains Ag, and a proportion of the Ag in composition is 4 weight % or larger.

According to this embodiment, in the case where the conductive ball is used to form, for example, an electrode, and the electrode is connected to, for example, a circuit board, the joint section may fulfill sufficient strength and heat resistance.

Moreover, in the first alloy, the proportion of Ag in composition is 4 weight % or larger, and therefore the liquidus temperature of the alloy is 240° C. or higher. In the case where the conductive ball is used as, for example, an external electrode material of electronic components, the coexistent state of a solidus portion and a liquidus portion exists at the temperature equal to or higher than the reflow temperature for securing sufficient connection with, for example, Ni widely used in lands of electronic components, and this state is effectively retained. Therefore, failures in, for example, an electrode formed with use of the conductive ball are effectively prevented.

In one embodiment, the first alloy contains Ag, and a proportion of the Ag in composition is 5.5 weight % or larger.

According to this embodiment, in the case where the conductive ball is used to form, for example, an electrode, and the electrode is connected to, for example, a circuit board, the joint section may fulfill sufficient strength and heat resistance.

Moreover, in the first alloy, the proportion of Ag in composition is 5.5 weight % or larger, and therefore the liquidus temperature of the alloy is 260° C. or higher. In the case where the conductive ball is used as, for example, an external electrode material of electronic components, the coexistent state of a solidus portion and a liquidus portion exists at temperatures equal to or higher than a typical reflow temperature, and the state is effectively retained. It is to be noted that the typical reflow temperature is a temperature in consideration of heat-resistant upper limit temperature as well as deterioration of joint strength attributed to excessive formation of intermetallic compounds in junction with the lands of electronic components. Therefore, for example, an electrode formed with use of the conductive ball can effectively and reliably prevent failures without exerting adverse influence due to heat on the electronic components and without causing deterioration of joint strength during reflow operation.

In one embodiment, in the first alloy, a proportion of the Ag in composition is smaller than 75 weight %.

According to this embodiment, the first alloy has Sn and Ag in composition and the proportion of the Ag is smaller than 75 weight %, and therefore the composition of the first alloy is noneutectic composition, as well as is the composition in which the liquidus temperature rises when the proportion of Sn in composition decreases, and is further the composition closer to the eutectic composition than to the composition of Ag₃Sn that is an intermetallic compound of Sn and Ag. Therefore, the eutectic structure in alloy provides sufficient strength.

Particularly, it is preferable that the proportion of Ag is larger than 3.5 weight % and smaller than 75 weight % because the coexistence of a solidus portion and a liquidus portion during reflow operation is reliably retained.

Further, it is preferable that the proportion of Ag is larger than 4 weight % and smaller than 75 weight % because the coexistence of a solidus portion and a liquidus portion can be retained at the reflow temperature which makes it possible to secure sufficient junction with Ni.

Moreover, it is preferable that the proportion of Ag is larger than 5.5 weight % and smaller than 75 weight % because the coexistence of a solidus portion and a liquidus portion during reflow operation can be retained when the reflow temperature is set at the heat-resistance upper limit temperature of electronic components or at temperatures which can avoid deterioration of the joint strength attributed to formation of intermetallic compounds.

In one embodiment, in the first alloy, a proportion of the Ag in composition is 37 weight % or lower.

According to this embodiment, the first alloy has Sn and Ag in composition and the proportion of the Ag is 37 weight % or smaller, and therefore the composition of the first alloy is noneutectic composition, as well as is the composition in which the liquidus temperature rises when the proportion of Sn in composition decreases, and is further the composition closer to the eutectic composition than to the composition of Ag₃Sn that is an intermetallic compound of Sn and Ag. Moreover, in the first alloy, an Ag₃Sn structure which is hard and inappropriate as a joint material is not more than 50% of a Sn matrix having appropriate ductility as a joint member. Therefore, the first alloy has sufficient strength and reliability as a joint member.

Particularly, it is preferable that the proportion of Au is larger than 3.5 weigh percent and smaller than 37 weight % because the coexistence of a solidus portion and a liquidus portion during reflow operation can reliably be retained.

Moreover, it is preferable that the proportion of Ag is larger than 4 weight % and smaller than 37 weight % because the coexistence of a solidus portion and a liquidus portion can be retained at the reflow temperature which makes it possible to secure sufficient connection with Ni.

Moreover, it is preferable that the proportion of Ag is larger than 5.5 weight % and smaller than 37 weight % because the coexistence of a solidus portion and a liquidus portion during reflow operation can be retained when the reflow temperature is set at the heat-resistance upper limit temperature of electronic components or at temperatures which can avoid deterioration of the joint strength attributed to formation of intermetallic compounds.

In one embodiment, in the first alloy, a proportion of the Ag in composition is 6.5 weight % or lower.

According to this embodiment, the first alloy has Sn and Ag in composition and the proportion of the Ag is 6.5 weight % or lower, and therefore the composition of the first alloy is noneutectic composition, as well as is the composition in which the liquidus temperature rises when the proportion of Sn in composition decreases. Further, it is the composition closer to the eutectic composition than to the composition of Ag₃Sn that is an intermetallic compound of Sn and Ag, and it is sufficiently close to the eutectic composition in which the proportion of Ag is 3.5 weight %. This makes it possible to obtain the mechanical strength roughly equal to that of the eutectic composition.

Particularly, it is preferable that the proportion of Ag is larger than 3.5 weight % and smaller than 6.5 weight % because the coexistence of a solidus portion and a liquidus portion during reflow operation is reliably retained.

Moreover, it is preferable that the proportion of Ag is larger than 4 weight % and smaller than 6.5 weight % because the coexistence of a solidus portion and a liquidus portion can be retained at the reflow temperature which makes it possible to secure sufficient connection with Ni.

Moreover, it is preferable that the proportion of Ag is larger than 5.5 weight % and smaller than 6.5 weight % because the coexistence of a solidus portion and a liquidus portion during reflow operation can be retained when the reflow temperature is set at the heat-resistance upper limit temperature of electronic components or at temperatures which can avoid deterioration of the joint strength attributed to formation of intermetallic compounds.

A formation method for an electrode of an electronic component of the present invention includes:

disposing the conductive ball on a land of an electronic component; and

heating the conductive ball disposed on the land of the electronic component, wherein

a maximum temperature for heating the conductive ball is a liquidus temperature of the first alloy or lower.

According to the structure, the conductive ball is disposed on the land of an electronic component and the conductive ball disposed on the land of the electronic component is heated. Since the maximum temperature for heating the conductive ball is a liquidus temperature of the first alloy or lower, the first alloy is put in the state in which a solidus portion and a liquidus portion coexist. The first alloy in this state has flowability lower than that in a completely melted state, and so the first alloy flows while keeping the state of covering the core and a second metal layer, and the first alloy is fixed on the land of the electronic component with satisfactory strength to form an electrode. As a result, joint failure of the electrode attributed to exposure of the second metal layer and the like as seen in the conventional example is effectively prevented and the electrode is fixed on the land of the electronic component with sufficient strength.

Moreover, the core formed of a nonmetallic material can gain elasticity when it is formed of, for example, resin. Therefore an electrode formed on the electronic component, if connected to, for example, a circuit board, can effectively relax stress, which is generated in a joint section between the electronic component and the circuit board, by the presence of the core. Thereby cracks and fractures in the joint section are effectively prevented.

A formation method for an electrode of an electronic component of the present invention includes:

disposing a joint member containing a third alloy on at least either the conductive ball or a land of an electronic component;

disposing the conductive ball on the land of the electronic component; and

heating the conductive ball and the joint member, wherein

a maximum temperature for heating the conductive ball and the joint member is a liquidus temperature of a first alloy of the conductive ball or lower, and is a liquidus temperature of a third alloy of the joint member or higher.

According to the structure, a joint member containing a third alloy is disposed on at least either the conductive ball or the land of an electronic component. The conductive ball is disposed on the land of the electronic component. Next, the conductive ball and the joint member are heated. The maximum temperature for heating the conductive ball and the joint member is a liquidus temperature of the first alloy of the conductive ball or lower, so that the state of the first alloy in which a solidus portion and a liquidus portion coexist is retained and flowability of the first alloy is made relatively low. Eventually, the first alloy can flow while retaining the state of covering the core and the second metal layer, which allows effective prevention of joint failure attributed to the exposure of a metal compound formed, for example, on the surface of the second metal layer. Further, since the maximum temperature for heating the conductive ball and the joint member is a liquidus temperature of the third alloy or higher, the joint member containing the third alloy melts sufficiently and is connected, with sufficient strength, to the land of the electronic component and the first metal layer made of conductive particles. As a result, it becomes possible to form an electrode free from joint failure and having good joint strength.

Moreover, the maximum temperature for heating the conductive ball and the joint member has only to be a liquidus temperature of the first alloy of the conductive ball or lower and a liquidus temperature of the third alloy of the joint member or higher, and therefore when heating temperatures vary by every electronic component during reflow process for heating, it becomes possible to stably form electrodes having good properties.

A formation method for an electrode of an electronic component of the present invention includes:

attaching flux to at least either the conductive ball or a land of an electronic component;

disposing the conductive ball on the land of the electronic component; and

heating the conductive ball, wherein

the flux contains 0.2 weight % or more halogen.

According to the structure, flux is attached to at least either a conductive ball or the land of an electronic component. The conductive ball with the flux attached thereto is disposed on the land of the electronic component, and the conductive ball disposed on the land of the electronic component is heated. The conductive ball has a core formed in a generally spherical shape and formed of a nonmetallic material and a coating layer formed of two or more metal layers for coating the surface of the core, and a first metal layer forming the coating layer is made of a first alloy containing Sn while a second metal layer forming the coating layer is made of a second alloy containing at least either Cu or Ni. Moreover, the flux contains 0.2 weight % or more halogen. Therefore, when the conductive ball is heated and the first alloy is melted, the surface tension of the melted first alloy is effectively reduced. This effectively prevents the first alloy from falling toward the land of the electronic component and the second alloy layer from being exposed. As a result, joint failure and insufficient strength of the electrode when the electrode is connected to a target section are prevented from occurring.

Moreover, the core formed of a nonmetallic material can gain elasticity when it is formed of, for example, resin. Therefore the electrode, if connected to, for example, a circuit board, can effectively relax stress, which is generated in a joint section between the electronic component and the circuit board, by the presence of the core. Thereby cracks and fractures in the joint section are effectively prevented.

An electronic component of the present invention has an electrode using the conductive ball.

According to the structure, the electrode formed with use of the conductive ball can prevent occurrence of joint failure and insufficient strength when it is connected to a target section such as a circuit board or a land of other electronic component. Therefore, it becomes possible to obtain an electronic component free from failures in the joint section and having stable performance.

An electronic component of the present invention has an electrode formed by the formation method for an electrode.

According to the structure, an electrode formed by using the formation method for an electrode is formed with use of the conductive ball, and therefore when the electrode is connected to a target section such as a circuit board or a land of other electronic component, occurrence of joint failure and the like can be prevented. Therefore, it becomes possible to obtain an electronic component having stable performance. Further, since the electrode can be formed under the reflow temperature condition similar to the conventional electronic component, it becomes possible to manufacture an electronic component having less inconvenience such as joint failure than the conventional electronic component by using conventional equipment under identical reflow conditions.

Electronic equipment of the present invention includes the electronic component.

According to the structure, thermal stress generated in the joint section between the electronic component and a circuit board due to changes in external environment temperature and heating of the circuit board can effectively be relaxed by the presence of the core of the conductive ball, so that cracks and fractures of the joint section can effectively be prevented. Moreover, since there is no exposure of intermetallic compounds on the surface of an electrode during formation of the electrode of the electronic component, joint failure in the joint section between the electronic component and the circuit board may be prevented from occurring. Moreover, since the electronic component can be mounted on the circuit board under the same conditions as the conventional electronic components, it becomes possible to mount the electronic component and conventional electronic component according to the locations in a mixed state.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a cross sectional view showing the structure of a conductive ball of the present invention;

FIGS. 2A and 2B are views showing the steps of forming an external electrode on an electronic component, in which FIG. 2A shows the state that a conductive ball member is disposed on a land of the electronic component while FIG. 2B is a view showing the state after reflow process;

FIGS. 3A and 2B are views showing the steps of forming a joint section between a circuit board and the electronic component, in which FIG. 3A is a view showing the state in which the electronic component is mounted on the land of the circuit board, while FIG. 3B is a view showing the state after reflow process;

FIG. 4 is a view showing changes in melting temperature of a SnAg-based alloy against changes in proportion of Ag content;

FIG. 5A is a view showing the result of measurement of share strength of bumps, while FIG. 5B is a view showing the result of measurement of pull strength of bumps;

FIG. 6 is a cross sectional view showing a joint section between a conventional electronic component and a circuit board;

FIG. 7 is a view showing a conventional conductive ball;

FIG. 8 is a view showing the state in which a joint section between an electronic component and a circuit board is formed with use of a conventional conductive ball;

FIGS. 9A, 9B and 9C are views showing the steps of forming a joint section using a conventional conductive ball;

FIG. 10 is a view showing a failure of the joint section in the case of using the conventional conductive ball; and

FIG. 11 is a schematic cross sectional view showing the state in which the conventional conductive ball is reflown.

### DETAILED DESCRIPTION OF THE INVENTION

Embodiments of the invention will now be described with reference to the accompanying drawings.

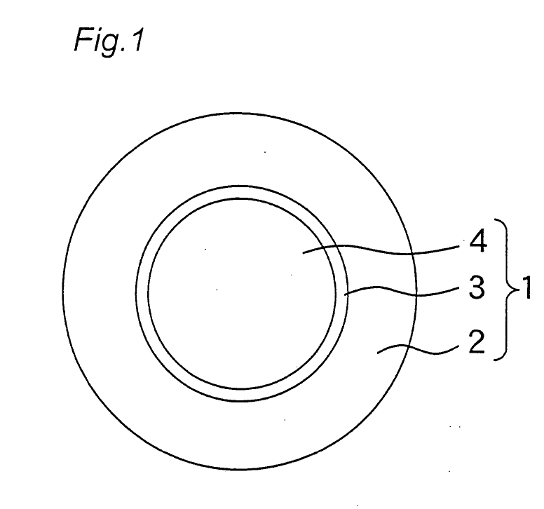

FIG. 1 is a cross sectional view showing the structure of a conductive ball member 1 as the conductive ball of the present invention. Inside the conductive ball member 1, there is a generally spherical-shaped core 4 made of a nonmetallic material. A Cu layer 3 is formed as the second metal layer on the surface of the core 4, and a solder alloy layer 2 is formed as the first metal layer on the surface of the Cu layer that is the outermost layer of the ball member. A coating layer is formed of the Cu layer 3 and the solder alloy layer 2, and the core 4 is coated with this coating layer.

The solder alloy layer 2 is formed of a SnAg-based alloy as the first alloy. The SnAg-based alloy has noneutectic composition and composition in which liquidus temperature rises when the proportion of Sn in composition decreases.

In the SnAg-based alloy, the proportion of Ag should preferably be larger than 3.5 weight % and smaller than 75 weight %. In this range, when the conductive ball is used as a joint member, an effect of preventing joint failure is fulfilled and in addition, an Sn matrix phase having appropriate ductility equal to the eutectic composition appears in the solder alloy layer, which allows obtention of excellent mechanical strength. Particularly, when the proportion of Ag is 37 weight % or lower, the Sn matrix phase accounts for not less than half of an Ag₃Sn compound phase created as an intermetallic compound, which allows further increase in mechanical strength.

Further, when the conductive ball member 1 is used as an external electrode material of an electronic component, it is necessary to efficiently diffuse the constituents of the solder alloy layer 2 and the material of the land for keeping connection of the electronic component to the land in good conditions. Particularly, when diffusion of Sn and Ni is in consideration, the reflow temperature of 240° C. or more is necessary. Herein, it is preferable that the proportion of Ag in the SnAg-based alloy is 4 weight % or larger, because then the liquidus temperature exceeds 240° C., and the coexistent state of a solidus portion and a liquidus portion during reflow operation can be realized, thereby allowing prevention of solder wetting failure during electronic component mounting.

Further, when the conductive ball member 1 is used as an external electrode material of an electronic component, the reflow temperature is often 260° C. or lower in consideration of the heat resisting temperatures of electronic components. Herein, it is preferable that the proportion of Ag in the SnAg-based alloy is 5.5 weight % or higher. If the proportion of Ag is 5.5 weight % or higher, then the liquidus temperature exceeds 260° C., and the coexistent state of a solidus portion and a liquidus portion can be reliably realized during reflow operation, thereby allowing prevention of solder wetting failure during electronic component mounting. Moreover, when the proportion of Ag is 6.5 weight % or less in particular, the composition is sufficiently close to the eutectic composition, and this makes it possible to obtain strength bearing comparison with the eutectic composition alloy, thereby ensuring sufficient strength as the joint member.

The coating layer may be formed of three or more layers, and another layer may be particularly disposed in between the solder alloy layer 2 and the core 4. However, the layer adjacent to the solder alloy layer 2 as the first metal layer should preferably be a layer formed of metals having sufficient wettability with the solder alloy containing Sn as its constituent. Typically, Cu, Ni or alloys containing these constituents are preferable. In the present embodiment, the Cu layer 3 is disposed adjacent to the solder alloy layer 2. Cu is a metal having sufficient wettability with Sn, so that integrity with the core 4 made of a nonmetallic material is desirably obtained. Moreover, the Cu layer 3 should preferably have a thickness of 3 μm or more in order to prevent the Cu layer 3 from disappearing by diffusion of Cu into the solder alloy layer 2 and diffusion of Sn from the solder alloy layer 2.

The prerequisite of the core 4 is that while the solder alloy layer 2 is melting, the core 4 should not melt nor decompose. Examples of the material of the core 4 include organic polymers and copolymers. While it is preferable to form the core 4 from, for example, epoxy resin, polyimide, polycarbonate, polyterephthalate and copolymers with use of these components, the material is not particularly limited to these as long as the material is not altered by a temperature of about 260° C. The elasticity of the core 4 formed of such organic materials is lower than the elasticity of the alloy forming the solder alloy layer 2. Therefore, when an electronic component with the electrode formed with use of the conductive ball member 1 is mounted on a circuit board, thermal stress generated in the joint section between the electronic component and the circuit board is primarily received by the core 4, and this makes it possible to relax the stress received by the solder alloy. As a result, fractures and the like in the joint section can effectively be prevented over a long period of time.

Moreover, as the nonmetallic material forming the core 4, inorganic materials having high melting points such as ceramics may also be used. In this case, when an electronic component is mounted on a circuit board, the core 4 does not melt and keeps its shape during reflow operation, so that a gap between the electronic component and the circuit board can be kept to be a distance no less than the diameter of the core 4. As a result, concentration of heat distortion generated in the soldered joint section upon the solder alloy can be reduced, thereby making it possible to effectively prevent disconnection and the like of the joint section over a long period of time.

In the present embodiment, a divinylbenzene copolymer formed by suspension polymerization method is used as the core 4. A catalyst was attached to the surface of the core 4, and the core 4 was plated with a thin coating of substitutional Ni (unshown), before a Cu layer 3 with a thickness of about 3 μm was formed by barrel plating method. Further, by the same method, SnAg plating was applied to form a SnAg layer 2 with a thickness of 15 to 20 μm so as to form a conductive ball member 1 as shown in FIG. 1. The conductive ball member 1 was formed in a generally spherical shape with a diameter of about 300 μm.

In the present embodiment, an external electrode of an electronic component was formed with use of the conductive ball member 1 to form a composite electrode with a resin core, and the electronic component was mounted on a circuit board.

(First Embodiment)

In this embodiment, with use of an alloy of Sn-5.5Ag composition as the solder alloy layer 2 of the conductive ball member 1, an external electrode was formed on the land of an electronic component. As the land, Cu plated with Ni and then flash plated with Au was used.

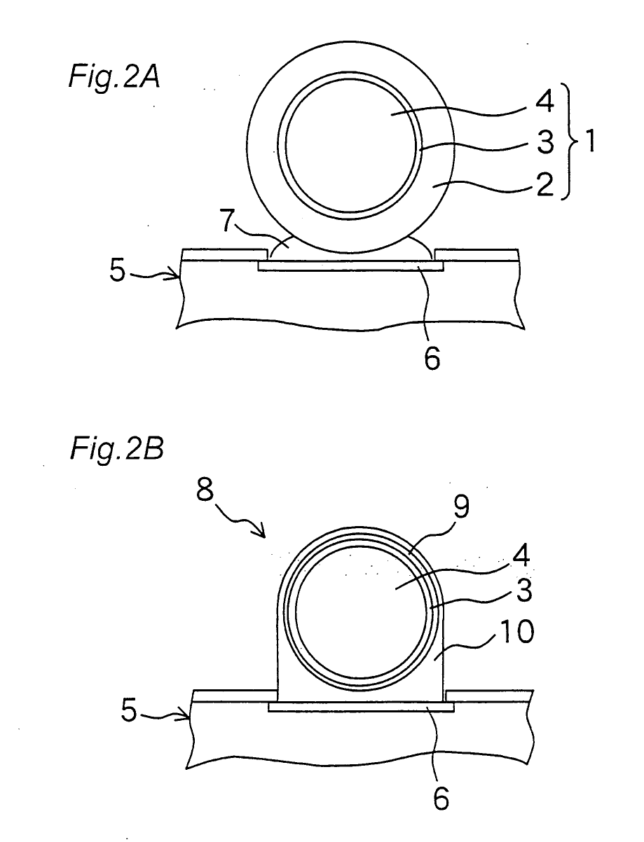

FIGS. 2A and 2B are views showing the steps of forming an external electrode on an electronic component. In FIG. 2A, the conductive ball member 1 is disposed on a land 6 of the electronic component via flux 7. The flux 7 needs appropriate activity for removing oxide layers on the surface of the solder alloy layer 2 and the surface of the land 6 to keep both the surfaces properly wet. However, since the flux 7 also becomes a residue after reflow process and causes corrosion of metal and the like, the flux 7 also needs to have appropriate removability. In the present embodiment, an RMA type Deltalux 523H (by Senju Metal Industry, Co., Ltd.) containing 0.04% Cl (chlorine) as halogen was used.

The method for applying the flux 7 on the surface of the land 6 includes transfer method using a pin, screen printing method, and method in which the flux is transferred onto the lower side of the ball member and is then directly mounted thereon. The method for mounting the conductive ball member 1 on the land 6 includes one with use of a mounter having a vacuum system, in which the conductive ball member 1 is vacuum sucked with use of a jig opened corresponding to the pattern of the land 6, and the vacuum suction is cancelled at a specified position for mounting the conductive ball member 1.

As shown in FIG. 2A, after the conductive ball 1 is disposed on the land 6 of the electronic component, the conductive ball member 1 is put into a reflow furnace to form an external electrode 8 by solder reflow operation. The electronic component on which the external electrode 8 is formed is a wafer level CSP, and in the step shown in FIG. 2A, the wafer level CSP is in a wafer state before being diced.

In the step for reflow operation, the major issue is whether or not the solder alloy of the conductive ball member 1 and the land 6 are sufficiently joined. The connection between the solder alloy and the land 6 is achieved by solid-liquid diffusion of Sn in the solder ally and Ni in the land 6. Since the diffusion phenomenon progresses faster at higher temperature, risk of formation of weak soldered joint sections has been pointed out in the case of Sn/Ni joint at considerably low temperature (e.g., M. Sumikawa et al., “Reliability of Soldered Joints in CSPs of Various Designs and Mounting Conditions,” IEEE Trans. Comp. and Packag. Technol. Vol. 24, No. 2, pp. 293-299, June 2001). Therefore, a recommended preset maximum temperature (peak temperature) in temperature change profile during reflow operation (reflow profile) is 240° C., and an upper limit of the peak temperatures is stipulated by heat-resisting temperatures of electronic components themselves. In the present embodiment, adopted was a condition widely adopted in general in consideration of temperature margins in the reflow process. More particularly, the peak temperature range for the surface of one batch of electronic components was 250 to 260° C.

FIG. 2B is a cross sectional view showing the external electrode 8 obtained by reflow of the conductive ball member 1 under this condition. In FIG. 2B, an SnCu compound layer 9 is formed in between a Cu layer 3 and a solder section 10 formed by melting of the solder alloy layer 2. The SnCu layer, which is formed by progress of the solid-liquid diffusion of Sn and Cu by heating in the reflow process, is formed to have a thickness of about 1 to 2 μm. While this phenomenon is unavoidable, the reflow is performed with use of the conductive ball member 1 of the present embodiment under this condition, which prevents the melted portion of the solder alloy layer 2 from falling toward the land 6. More particularly, since an alloy of Sn-5.5Ag composition that is noneutectic composition was used as the solder alloy layer 2 of the conductive ball, the solder alloy layer 2 has a solidus portion and a liquidus portion coexisting during reflow operation at the peak temperature in the range of 250 to 260° C. As a result, flowability of the solder alloy layer 2 is controlled and exposure of the SnCu compound layer 9 is prevented. Therefore, failures generated in the joint section between the electronic component and the circuit board attributed to the SnCu compound layer 9 as seen in the conventional cases can reliably be prevented.

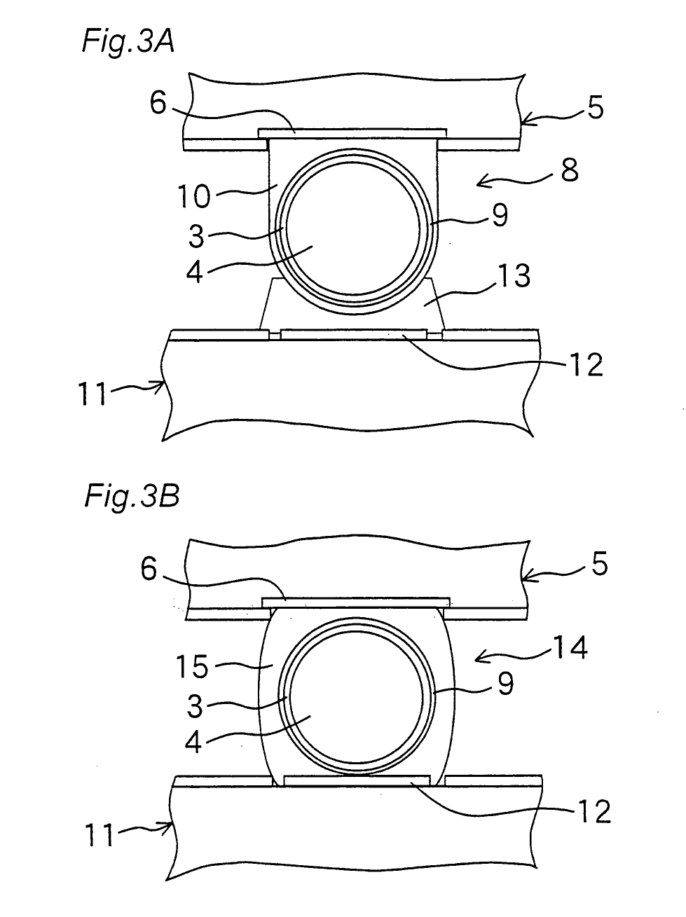

Description is now given of the step of mounting an electronic component 5 with an external electrode 8 formed thereon on a circuit board 11. First, as shown in FIG. 3A, a solder paste 13 as a joint member is applied to a land 12 of the circuit board 11, and the electronic component 5 is mounted thereon. The electronic component 5 is a wafer level CSP obtained by dicing a wafer into pieces after the external electrode 8 is formed. The solder paste 13 is collectively fed to almost all the lands 12 disposed on the circuit board 11 by screen printing method. As a third alloy for forming the solder paste 13, SnPb-based, SnAg-based and SnAgCu-based solder materials may be used. In the present embodiment, the solder paste containing solder particles of Sn-3Ag-0.5Cu composition was used.

Then, the electronic component 5 and the circuit board 11 are sent in a reflow furnace where reflow operation is conducted. As for heating temperature in the reflow furnace, a peak temperature at which appropriate soldered joint is formed between the external electrode 8 and the circuit board land 12 is set. More particularly, the upper temperature is determined based on the heat-resisting temperature of a component having the lowest heat resistance among all the electronic components to be mounted on the circuit board 11. In the present embodiment, a reflow profile having a peak temperature of about 240 to 250° C. was used.

After the reflow operation is conducted, the residue of the flux is cleaned by a cleaning solvent. Then, as shown in FIG. 3B, a soldered joint section 14 is formed in between the electronic component 5 and the circuit board 11. In the soldered joint section 14, on the outside of the core 4, the Cu layer 3, the SnCu compound layer 9 and a solder section 15 is formed. The solder section 15 is formed by the solder section 10 of the external electrode and the solder paste 13 fed to the land 12 of the circuit board 11, the solder section 10 and the solder paste 13 being melted and sufficiently mixed with each other. In this case, such problems as generation of the interface 17 as seen in conventional cases was avoided because in the external electrode 8 shown in FIG. 2B, the SnCu layer 9 was not exposed but was coated with the SnAg solder alloy section 10.

Actually, under the same conditions as the formation condition of the external electrode 8 and the mounting condition of the electronic component 5 on the circuit board 11 described above, fifty wafer level CSPs in total as electronic components were connected to seven hundred and forty nine pins in total, and it was confirmed that sufficient connection could be obtained.

Thus, it was confirmed that the external electrode 8 according to the present embodiment did not cause exposure of the SnCu layer. Whether or not the external electrode 8 is perfectly solder-joined to the land 6 of the electronic component is in trade off relation with the exposure issue of the SnCu layer. In an extreme example, if the reflow process is finished with the solder alloy layer 2 in an unmelted state, then the exposure of the SnCu layer does not occur and the soldered joint to the land 6 is not achieved either.

In order to confirm the soldered joint of the external electrode 8 to the electronic component 5, measurement of shear strength of the external electrode 8 was conducted. More particularly, loads in shear direction were applied to the external electrode 8 and loads which caused shear were measured. As a result of measuring the shear strength of five electrodes, the maximum value of loads was 4.857N, the minimum value was 3.789N and the average value was 4.152N.

For comparison, with use of a conductive ball member having an Sn-3.5Ag alloy that is eutectic composition of an SnAg alloy as a solder alloy layer formed on the outermost layer, an external electrode was formed under the same conditions as those in the first embodiment and the shear strength of the external electrode was measured. As a result, the maximum value of loads was 3.97N, the minimum value was 2.443N and the average value was 3.125N. Peak temperatures 250 to 260° C. in reflow profile during formation of electrodes in the present embodiment were high enough in proportion to the melting point 221° C. of the Sn-3.5Ag solder alloy that is eutectic composition. More particularly, the Sn-3.5Ag solder alloy is appropriately solder-connected to the land 6. In this case, the external electrode using the Sn-3.5Ag solder alloy in the present embodiment has sufficient bump shear strength compared to the external electrode using the Sn-3.5Ag alloy of eutectic composition. Therefore, it can be said that the external electrode 8 according to the present embodiment has no problem with respect to the joint strength of the electronic component to the land 6.

In general, alloys gain the largest strength when in eutectic composition. In the case of SnAg-based alloys, a primary crystal of Ag₃Sn is formed when the alloys are solidificated from the melted state, and this fine and hard primary crystal scatters in an eutectic structure to bring about sufficient strength (e.g., “Pb-free Solder Technique Practice Handbook” supervised by Suganuma Katsuaki, Realize CO., Ltd, Tokyo (2000)). Herein, if Ag in the alloy composition is increased, the farther the composition is away from the eutectic composition, the more the Ag₃Sn structure is coarsened, and this leads to deterioration of the alloy strength.

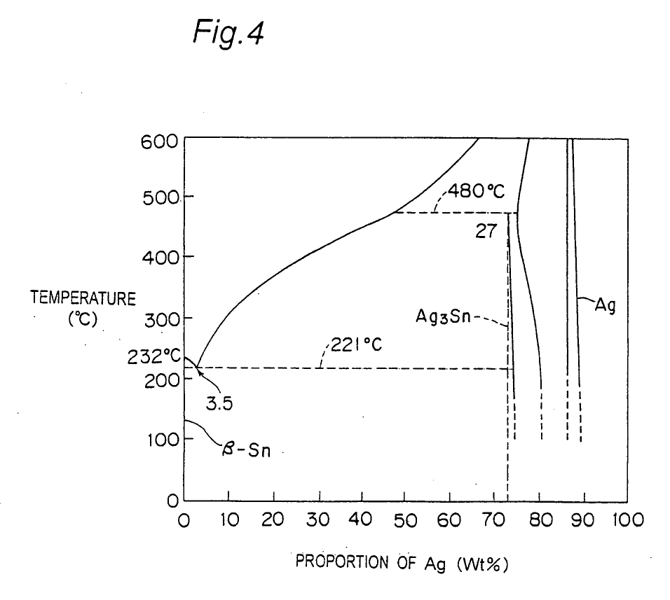

In the case of SnAg-based alloys, the melting temperatures against the proportion of an Ag content is largely different between the Sn-3.5Ag alloy of eutectic composition and an Sn-5.5Ag alloy as shown in FIG. 4 (see M. Hansen: “Constitution of Binary Alloys”, Mc Graw-Hill Book Co., Inc, New York (1958)). In order to determine whether or not the Sn-3.5Ag alloy of eutectic composition and the Sn-5.5Ag alloy of noneutectic composition are appropriate as soldered joint sections, bumps were formed with use of ball members (without a nonmetallic core) having these solder compositions, and an experiment for measuring the strength of these bumps was conducted.

In this experiment, the strength of a bump formed with use of an Sn-6Ag alloy whose composition is farther away from the eutectic composition than the Sn-5.5Ag alloy and a bump formed with use of the Sn-3.5Ag alloy were measured. The balls used for forming the bumps had a diameter of 0.3mmΦ. The lands used for forming the bumps had a diameter of 0.28 mmΦ. Moreover, the flux used in the first embodiment was used to perform reflow at 250° C. for forming the bumps.

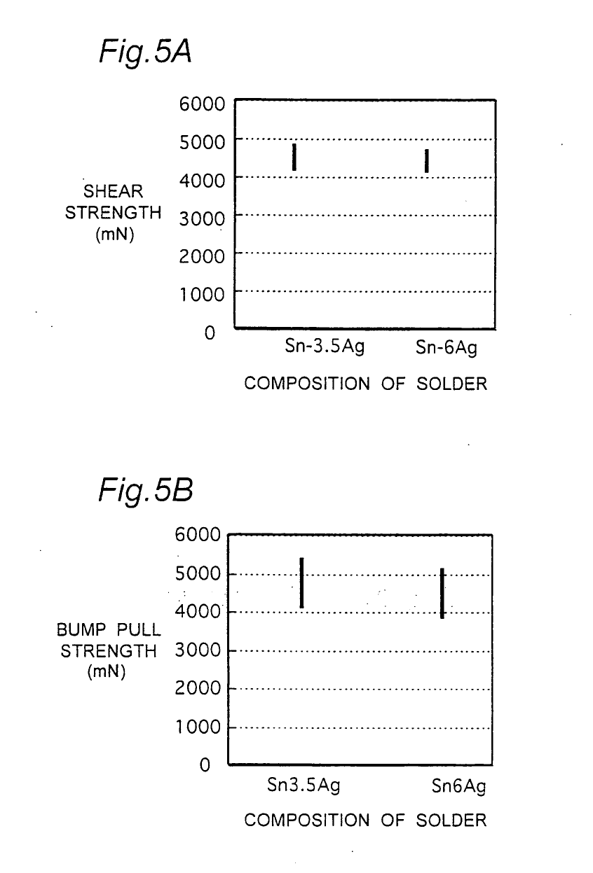

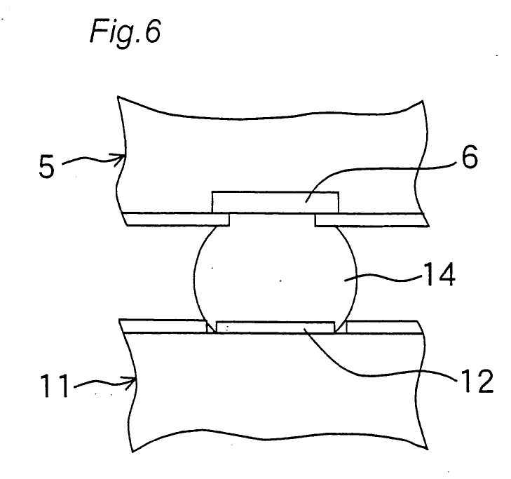

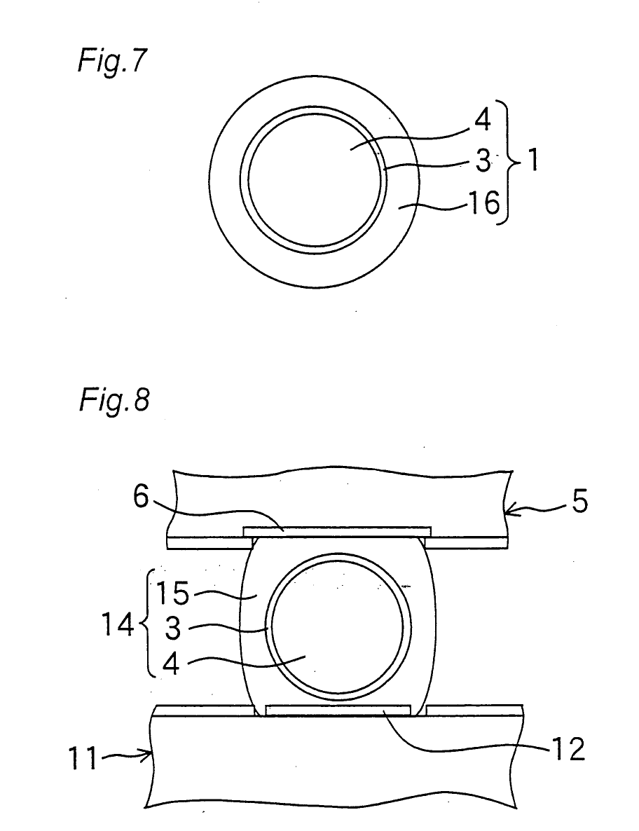

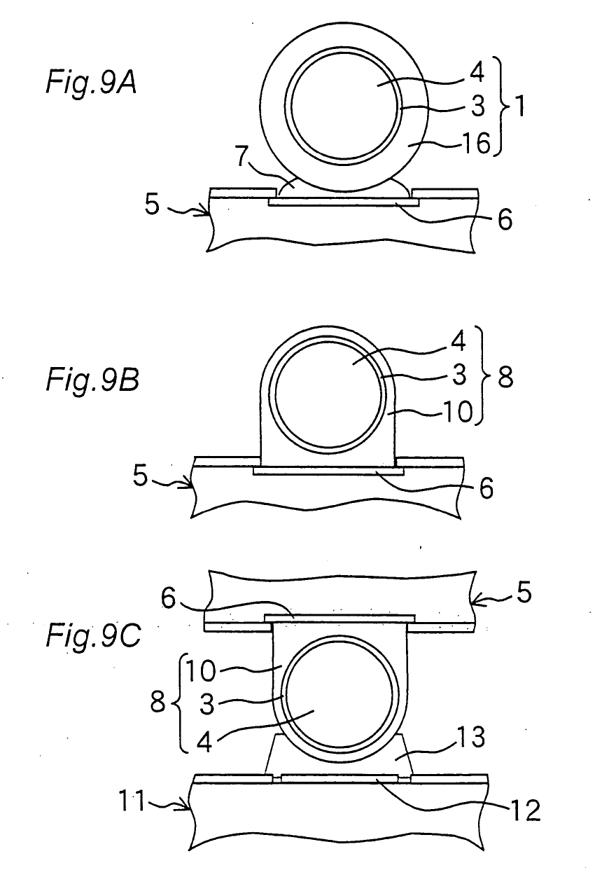

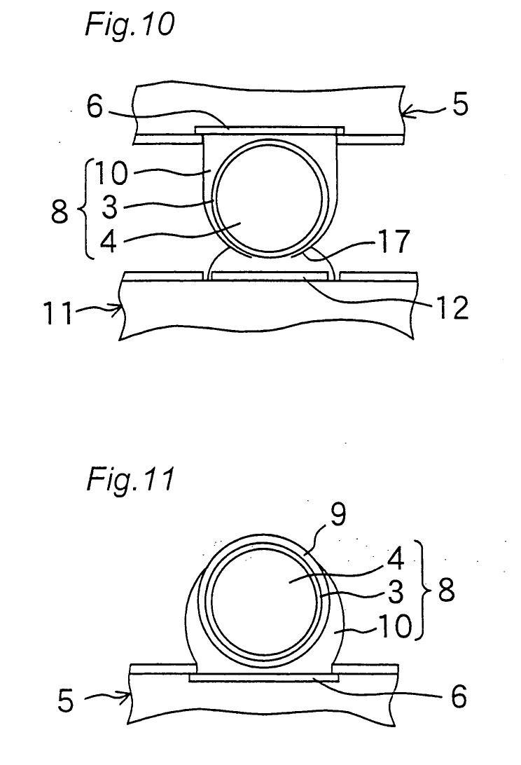

FIGS. 5A and 5B are views showing the result of measurement of the strength of the bumps. FIG. 5A shows the result of a shear test showing the shear strength of the bumps. As shown in FIG. 5A, the bump made of the Sn-6Ag alloy had the strength equal to the bump made of the Sn-3.5Ag alloy. Moreover, FIG. 5B shows the result of a bump pull test. The bump pull test is to measure the fracture strength of the bumps formed of solder alloys when the alloys are held and pulled by a tool. As shown in the result in FIG. 5B, the bump made of the Sn-6Ag alloy has the strength equal to the bump made of the Sn-3.5Ag alloy.

Since the Sn-5.5g alloy in the first embodiment is closer in terms of composition to the Sn-3.5Ag alloy of eutectic composition than to the Sn-6Ag alloy, it can be said that the Sn-5.5g alloy can gain more sufficient strength than the Sn-6Ag alloy. From these facts, the conductive ball member with use of the SnAg alloy of noneutectic composition, particularly the Sn-5.5g alloy, as a surface layer can obtain soldered joint with sufficient strength while avoiding such problems as wetting failure during circuit board mounting operation under the manufacturing conditions generally identical to the conventionally used manufacturing conditions.

(Comparative Example 1)

The composition of the first alloy which allows formation of an appropriate external joint electrode and the range of reflow temperatures for the conductive ball member in the first embodiment were examined. Herein, with use of a plurality of conductive ball members having the first metal layer formed of SnAg alloys of plural kinds of composition, electrodes identical to those in the first embodiment were formed on lands at a plurality of reflow temperatures. Then, it was observed whether or not exposure of an SnCu layer on the surfaces of the electrodes occurred. The flux identical to that in the first embodiment, RMA type Deltalux 523H (by Senju Metal Industry, Co., Ltd.), was used. The reflow operation was performed with hot plates set at each temperature, and it was observed whether or not an SnCu layer was exposed on the surfaces of the electrodes at the point of time when 30 seconds have passed after heating. Table 1 shows the result of the observation, in which exposure of the SnCu layer is denoted by × while no exposure is denoted by ◯. Table 1 also shows the solidus temperature and the liquidus temperature of each SnAg composition read from FIG. 4.

TABLE 1

| | | solidus | liquidus | | | | | | | |
|---|---|---|---|---|---|---|---|---|---|---|
| | | temperature | temperature | Reflow temperature (° C.) | | | | | | |
| | | (° C.) | (° C.) | 230 | 240 | 250 | 260 | 280 | 300 | 320 |
| Composition | Sn—3.5Ag | 221 | 221 | x | x | x | x | | | |
| | Sn—4.6Ag | 221 | 244 | | ∘ | x | x | | | |
| | Sn—5.5Ag | 221 | 260 | | | ∘ | ∘ | x | | |
| | Sn—7.2Ag | 221 | 282 | | | ∘ | ∘ | ∘ | x | x |
| | Sn—10Ag | 221 | 308 | | | ∘ | | | | |

As shown in Table 1, when reflow is performed at temperatures higher than the liquidus temperature, the exposure of the SnCu layer occurs. This is because at temperatures higher than the liquidus temperature, the flowability of the SnAg alloy becomes relatively high and the alloy falls toward the land, causing exposure of the SnCu layer having relatively poor solder wettability.

More particularly, by heating the conductive ball member during reflow operation, the solid-liquid diffusion phenomenon of Sn in the solder alloy of the first metal layer and the Cu layer positioned inside thereof progresses. The solder melted at temperatures higher than the solidus temperature falls toward the land under the influence of the flowability of the solder, gravity acting upon the solder and wettability between the solder and the surface which comes into contact with the solder. If the solder is in a complete melted state, all of the solder falls down to the land due to low viscosity, causing the SnCu layer to be exposed on the surface of the electrode. If the reflow is performed at temperatures equal to or higher than the solidus temperature and equal to or lower than the liquidus temperature, then the solder is put in the solid-liquid coexistent state in which part of the solder is melted, which prevents all of the solder from falling down to the land. Even in the case of the reflow connection in the solid-liquid coexistent state, the soldered joint with sufficient strength can be obtained as described in the first embodiment.

As seen in the result of Table 1, it can be said that the reflow at temperatures not more than the liquidus temperature is the condition to form electrodes which do not cause wetting failure during board mounting. Moreover, according to Table 1, the composition which does not cause exposure of the SnCu layer which attributes to wetting failure at reflow temperatures of about 250 to 260° C. which are generally used during electrode formation is the composition having the proportion of an Ag content larger than that in the Sn-5.5Ag. However, since excessive deviation from the eutectic composition leads to fragile solder structures, it is preferable to use solder alloys whose Ag content is ±0.5% around Sn-6Ag.

(Comparative Example 2)

Although in the comparative example 1, the conductive ball members were left for 30 seconds on the hot plate set at each temperature to observe the fall of the solder, the heating condition was stricter than the heating condition used for the actual reflow process. In the actual reflow process, a belt driven type reflow furnace is used and so the conductive ball members reach the peak temperature momentarily. Moreover, a period of time during which the conductive ball members are exposed to temperatures lower than the peak temperature by approximately 5° C. is about 5 to 10 seconds. Accordingly, in order to examine the influence of heating time during the reflow operation, with use of only the solder alloy of Sn-4.6Ag composition, electrodes were formed of conductive ball members at heating temperatures of 240 to 260° C. for varied heating time, and the state of their surfaces were examined. Other conditions such as the material of the flux are identical to those in the comparative example 1. Table 2 is a table showing the result. As with Table 1, the exposure of the SnCu layer is denoted by × while no exposure is denoted by ◯. Symbol ● denotes partial exposure of the SnCu layer when an experiment is conducted a plurality of times under the same conditions.

TABLE 2

| Reflow time (s) | | | | | | |
|---|---|---|---|---|---|---|
| 5 | 10 | 20 | 30 | 40 | 60 | 80 |

| | | | | | | | | |
|---|---|---|---|---|---|---|---|---|
| Reflow | 240 | | | ∘ | | | | ∘ |
| temperature | 250 | | | x | | x | x | |
| (° C.) | 255 | | | | x | | | |
| | 260 | ● | ● | x | X | | | |

As shown in Table 2, all the results under the reflow condition of 240° C. was satisfactory. The liquidus temperature of Sn-4.6Ag in the present comparative example is 244° C., and it is indicated that the reflow operation at not more than the liquidus temperature does not cause the exposure of the SnCu layer.

However, in consideration of the liquidus temperature of alloys, all the reflow temperatures not less than 250° C. should be marked by × in Table 2. However, the result of Table 2 indicates that if the reflow time is as short as about 10 seconds or less at the reflow temperature of 260° C., then the SnCu layer is not always exposed. Therefore, it may be concluded that the exposure of the SnCu layer is caused not only by the reflow temperature but also by a plurality of causes including the reflow time and later-described flux materials.

In the reflow process employed in general manufacturing process, variation of heating temperatures are generated even among works in the same batch. Therefore, when the peak temperature as the reflow condition is set at a specified temperature, a plurality of conductive ball members on a work during the reflow process have variation in peak temperature. Moreover, in the case where the peak temperature in heating is maintained for about 30 seconds, a period of time during which each conductive ball is kept at the peak temperature also varies. In consideration of the variation attributed to such various causes, Tables 1 and 2 indicate that keeping the reflow temperature at the liquidus temperature or lower makes it possible to prevent soldered joint failures at high efficiency.

(Comparative Example 3)

In the present comparative example, with use of the conductive ball members having an Sn-3.5alloy as the first alloy, examination similar to that in the comparative example 2 was conducted. The exposure of an SnCu layer in the case where the reflow temperature was fixed to 230° C., and electrodes were formed with use of a RMA (Rosin Mildly Activated) flux was examined with a plurality of reflow time sets. As the flux, Deltalux 523H (RMA flux) was used. Table 3 shows the result, in which exposure of the SnCu layer similar to the comparative example 2 is denoted by ×, no exposure is denoted by ◯ and partial exposure in a plurality of reflow operations is denoted by ●.

TABLE 3

Reflow time (s)

| | | 2 | 5 | 10 | 20 |
|---|---|---|---|---|---|
| Reflow | 230 | ∘ | ● | x | x |
| temperature | | | | | |
| (° C.) | | | | | |

As shown in Table 3, when the conductive ball members with use of an Sn-3.5Ag alloy as the first alloy is heated with a RMA flux at 230° C. for 5 seconds or longer, the exposure of the SnCu layer starts. This temperature condition is considerably lower as the reflow temperature employed in general manufacturing process. Occurrence of the exposure of the SnCu layer at this temperature in about 5 seconds is a problem. Therefore, it can be said that when the Sn-3.5Ag alloy is used in the conductive ball members, the RMA flux is not desirable.

(Second Embodiment)

In the present embodiment, electrodes were formed of solder alloys of Sn-3.5Ag with flux different from that in the first embodiment. Since the step for forming electrodes are identical to that in the first embodiment, detailed description is omitted. The difference from the first embodiment is that as flux, Deltalux 533 (by Senju Metal Industry, Co., Ltd.) that is a high halogen content type (RA type) is used. The flux contains 0.22% Cl. It is to be noted that as the reflow temperature condition, the peak temperature of 240° C. was employed.

In the electrodes in the present embodiment, the exposure of the SnCu layer was not confirmed. This may be because a content of Cl elements contained in the flux is increased from 0.04% in the first embodiment to 0.2%, and the activity of the flux is enhanced. With the enhanced activity of the flux, even the solder alloy of Sn-3.5Ag can avoid the exposure of the SnCu layer, i.e., wetting failure. Therefore, even in the case where the SnAg alloys of noneutectic composition are used, the margin of the reflow condition which prevents exposure of the SnCu layer found in the first embodiment can be enlarged and the exposure of the SnCu layer can be prevented more reliably.

The prevention of the exposure of the SnCu layer achieved in the present embodiment may be explained as shown below. That is, during reflow operation for electrode formation, the first metal layer of the conductive ball member melts. At this point, the flux coats the surface of the melted first metal layer to reduce the surface tension of the first metal layer. The surface tension acting on the melted first metal layer, i.e., the solder alloy, is the force working to keep the melted solder in a spherical shape. Therefore, the surface tension, if too large, acts as the force to discharge the core out of the melted solder. More particularly, the surface tension acts as the force to expose the SnCu layer formed on the outer surface of the core. By increasing the activity of the flux, the effect of reducing the surface tension of the solder is increased, by which the force to discharge the core out of the melted solder can be suppressed to avoid the exposure of the SnCu layer.

The wetting force between the SnCu layer and the metal layer made of the first alloy increases as the flux becomes highly activated.

By setting an amount of halogen contained in the flux at 0.2% or more, both the action relating to the surface tension and the action relating to the wetting force make it possible to effectively prevent the SnCu layer from being exposed from the surface of the electrode. However, use of the flux containing a large amount of halogen has issues of cleaning of flux residue and waste liquid treatment in view of environment preservation, and therefore the use of the flux needs to be kept to the required minimum.

While the embodiments regarding the SnAg-based alloys have been described above, the problem that exposure of a metallic compound layer with relatively poor solder wettability causes joint failure of electrodes and the like is not limited to the SnAg-based alloys. This problem similarly arises not only in the SnAg-based alloys but also in SnPb-based, SnZn-based and SnBi-based alloys. In alloys of any base, by the surface tension generated in the melted alloys during melting process by reflow and the other operation as well as by the gravity acting upon the melted alloys, the melted alloys fall toward the lands of electronic components, thereby causing the exposure of the metallic compound layer.

Therefore, in the SnPb-based alloys, the proportion of Pb in composition should preferably fall within the range of 38.1% to 80.8%. Moreover, in the SnBi-based alloys, the proportion of Bi in composition should preferably fall within the range of 57% to 99.9%. Moreover, in the SnZn-based alloy, the proportion of Zn in composition should preferably fall within the range of 8.8% to 99.9%. The SnPb-based, SnBi-based and SnZn-based alloys are respectively have solidus temperatures of 183° C., 138° C. C and 198.5° C., and when the proportion of each metal in each composition is within each of the ranges, the liquidus temperature increases as the proportion of an Sn content decreases. Therefore, in the alloys of any bases, when Sn constituent in the first alloy decreases due to the diffusion phenomenon of metals occurring in the first alloy layer and the second ally layer during reflow operation, the liquidus temperature increases and the state in which a solidus portion and a liquidus portion stably coexist can be retained. As a result, the metallic compound layer having poor solder wettability may be effectively prevented from being exposed on the surface of the electrode, which allows effective prevention of failures during mounting of electronic components on a circuit board.

Although above embodiments have been described with wafer process CSPs as examples of the electronic components of the present invention, the electronic components may also be bear chips. In the case where electronic components are mounted on a printed board and the like, thermal stress corresponding to a difference in thermal expansion coefficient between the material of land formation sections of the electronic components and a printed board material such as glass epoxy is exerted over the soldered joint section. In the bear chips and the wafer process CSPs, a thin film made of insulative resin such as polyimide is formed on a semiconductor substrate made of Si, and the lands are formed on the thin film. In the case of conventional CSPs, the lands were formed on molded resin, and since Si has larger difference in thermal expansion coefficient from glass epoxy than the molded resin, heat distortion generated in the soldered joint becomes larger. Therefore, by using the conductive ball of the present invention, the core incorporated in the conductive ball makes it possible to keep the height of the soldered joint section and to relax the concentration of the heat distortion, by which the reliability of the electronic components can be enhanced.

Electronic equipment on which the electronic components of the present invention are mounted includes server computers and cell-phones. This is because the server computers have a large heating value from internal circuit boards and have large temperature changes inside the equipment, which makes it necessary to enhance the reliability of the soldered joint section with respect to the temperature changes. Moreover, in the case of the cell-phones, mass production and short product cycle lead to a high annual abandonment volume, by which the cell-phones have larger influence on the environment than other electronic equipment. Further, since the cell-phones are mobile equipment, their external environment temperatures widely vary as owners of the cell-phones move, and therefore the soldered joint section needs high reliability with respect to the temperature changes. Accordingly, in the formation method for an electrode of the present invention, an external connection electrode and a soldered joint section not containing Pb can be formed with use of a non-halogen flux, which makes it possible to reduce the environment load when the cell-phones are manufactured or abandoned. Further, since the soldered joint section has high reliability with respect to the temperature changes, it becomes possible to enhance the reliability of the electronic equipment itself.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A conductive ball comprising:
a core formed in a generally spherical shape and formed of a nonmetallic material; and
a coating layer coating a surface of the core and having at least a first metal layer and a second metal layer, wherein,
the first metal layer is made of a first alloy containing Sn and having noneutectic composition, and
the second metal layer is made of a second alloy containing at least either Cu or Ni.

2. The conductive ball as defined in claim 1, wherein
the first alloy has composition in which a liquidus temperature rises when a proportion of Sn in composition decreases.

3. The conductive ball as defined in claim 2, wherein
the first alloy has composition closer to eutectic composition than to composition whose constituent forms an intermetallic compound.

4. The conductive ball as defined in claim 2, wherein
the first alloy has composition in which a liquidus temperature is 240° C. or higher.

5. The conductive ball as defined in claim 2, wherein
the first alloy has composition in which a liquidus temperature is 260° C. or higher.

6. The conductive ball as defined in claim 1, wherein
the first alloy contains Ag, and a proportion of the Ag in composition is larger than 3.5 weight %.

7. The conductive ball as defined in claim 1, wherein
the first alloy contains Ag, and a proportion of the Ag in composition is 4 weight % or larger.

8. The conductive ball as defined in claim 1, wherein
the first alloy contains Ag, and a proportion of the Ag in composition is 5.5 weight % or larger.

9. The conductive ball as defined in claim 5, wherein
in the first alloy, a proportion of the Ag in composition is smaller than 75 weight %.

10. The conductive ball as defined in claim 5, wherein
in the first alloy, a proportion of the Ag in composition is 37 weight % or lower.

11. The conductive ball as defined in claim 5, wherein
in the first alloy, a proportion of the Ag in composition is 6.5 weight % or lower.

12. A formation method for an electrode of an electronic component comprising:
disposing the conductive ball as defined in claim 1 on a land of an electronic component; and
heating the conductive ball disposed on the land of the electronic component, wherein
a maximum temperature for heating the conductive ball is a liquidus temperature of the first alloy or lower.

13. A formation method for an electrode of an electronic component comprising:
disposing a joint member containing a third alloy on at least either the conductive ball as defined in claim 1 or a land of an electronic component;
disposing the conductive ball on the land of the electronic component; and
heating the conductive ball and the joint member, wherein
a maximum temperature for heating the conductive ball and the joint member is a liquidus temperature of a first alloy of the conductive ball or lower, and is a liquidus temperature of a third alloy of the joint member or higher.

14. A formation method for an electrode of an electronic component comprising:
attaching flux to at least either the conductive ball as defined in claim 1 or a land of an electronic component;
disposing the conductive ball on the land of the electronic component; and
heating the conductive ball, wherein
the flux contains 0.2 weight % or more halogen.

15. An electronic component having an electrode using the conductive ball as defined in claim 1.

16. An electronic component having an electrode formed by the formation method for an electrode as defined in claim 12.

17. An electronic component having an electrode formed by the formation method for an electrode as defined in claim 13.

18. An electronic component having an electrode formed by the formation method for an electrode as defined in claim 14.

19. Electronic equipment including the electronic component as defined in claim 15.

20. Electronic equipment including the electronic component as defined in claim 16.

21. Electronic equipment including the electronic component as defined in claim 17.

22. Electronic equipment including the electronic component as defined in claim 18.
